(19) United States
(12) Patent Application Publication
(10) Pub. No.: US 2026/0092647 A1
(43) Pub. Date: Apr. 2, 2026

(54) ANNULAR METAL SEAL FOR PENETRATOR

(71) Applicant: POWER FEED-THRU SYSTEMS AND CONNECTORS LLC, DEER PARK, TX (US)

(72) Inventor: ROY L. KINKAID, PORT BOLIVAR, TX (US)

(21) Appl. No.: 19/348,710

(22) Filed: Oct. 2, 2025

Related U.S. Application Data
(60) Provisional application No. 63/702,217, filed on Oct. 2, 2024.

(51) Int. Cl. F16J 15/02

(52) U.S. Cl. CPC F16J 15/022

(57) ABSTRACT

An annular metal seal for penetrators in oil and gas applications. The annular metal seal utilizes a metal ring seal disposed between a penetrator and housing with the outer and inner diameter of the metal ring seal configured to accommodate interference fits. A clamping yoke or other conventional means of applying force may be employed to maintain the desired load against the metal ring seal.

### CITATION TO PRIOR APPLICATIONS

The present application claims priority to U.S. Provisional Application No. 63/702,217, titled “ANNULAR METAL SEAL FOR PENETRATOR” and filed on Oct. 2, 2024, which is, along with all references therein, entirely incorporated by reference herein

### BACKGROUND AND SUMMARY

The present disclosure is directed to sealing technology for use in oil and gas operations.

Conventional sealing methods for the annulus of an electrical penetrator rely on elastomeric components. These elastomeric solutions are prone to degradation of sealing ability over time and susceptible to deterioration caused by exposure to well fluids, pressure, and temperature over time.

The present disclosure provides a metal to metal sealing solution for an electrical penetrator that avoids these drawbacks. A metal seal for a penetrator in accordance with this disclosure will provide operators employing electronic submersible pumps (“ESPs”), or other equipment that requires electrical feed-thru penetrators, an improved approach to sealing that better maintains a seal's efficacy and longevity.

Non-limiting, exemplary embodiments of this system are depicted in the accompanying figures.

### BRIEF DESCRIPTION OF THE DRAWINGS

The preceding aspects and many of the attendant advantages of the present disclosure will become more readily appreciated by reference to the following Detailed Description when taken in conjunction with the accompanying drawings of example embodiments. The drawings briefly described below are presented for ease of explanation and do not limit the scope of the claimed subject matter.

FIG. 1A depicts a perspective view of an annular metal sealing system in accordance with embodiments of the present disclosure.

FIG. 1B depicts a cross-sectional view of an annular metal sealing system in accordance with embodiments of the present disclosure.

FIG. 2A depicts a perspective view of an annular metal sealing system in accordance with embodiments of the present disclosure.

FIG. 2B depicts a cross-sectional view of an annular metal sealing system in accordance with embodiments of the present disclosure.

FIG. 3A depicts a perspective view of an annular metal sealing system in accordance with embodiments of the present disclosure.

FIG. 3B depicts a cross-sectional view of an annular metal sealing system in accordance with embodiments of the present disclosure.

FIG. 4A depicts a perspective view of an annular metal sealing system in accordance with embodiments of the present disclosure.

FIG. 4B depicts cross-sectional view of an annular metal sealing system in accordance with embodiments of the present disclosure.

FIG. 5A depicts a perspective view of a metal ring seal in accordance with embodiments of the present disclosure.

FIG. 5B depicts a cross-sectional view of a metal ring seal in accordance with embodiments of the present disclosure.

FIG. 6A depicts a perspective view of a metal ring seal in accordance with embodiments of the present disclosure.

FIG. 6B depicts a cross-sectional view of a metal ring seal in accordance with embodiments of the present disclosure.

FIG. 7A depicts a perspective view of a metal ring seal in accordance with embodiments of the present disclosure.

FIG. 7B depicts a cross-sectional view of a metal ring seal in accordance with embodiments of the present disclosure.

FIG. 8A depicts a perspective view of a metal ring seal in accordance with embodiments of the present disclosure.

FIG. 8B depicts a cross-sectional view of a metal ring seal in accordance with embodiments of the present disclosure.

FIG. 9 depicts a perspective view of an annular metal sealing system in accordance with embodiments of the present disclosure.

FIG. 10 depicts a perspective view of a metal ring seal in accordance with embodiments of the present disclosure.

### DETAILED DESCRIPTION

Embodiments of a sealing system in accordance with the present disclosure comprises a metal ring seal 100, a force applicator 200, an upper mating tube 300, and a lower mating tube 400. As will be set forth in greater detail below, metal ring seal 100 is configured to engage with the upper mating tube 300 and lower mating tube 400 with an interference fit. Force applicator 200 may serve to ensure a sufficient load is supplied and maintained while also resisting axial movement of metal ring seal 100.

In some embodiments of the present disclosure, upper mating tube 300 may be an electrical penetrator, and lower mating tube 400 may be any other conventional tubing normally interfaced with an electrical penetrator via a pressure barrier. For example, lower mating tube 400 may be a housing such as, but not limited to, a tubing bonnet or adapter, a tubing hanger, a downhole packer, or a POD.

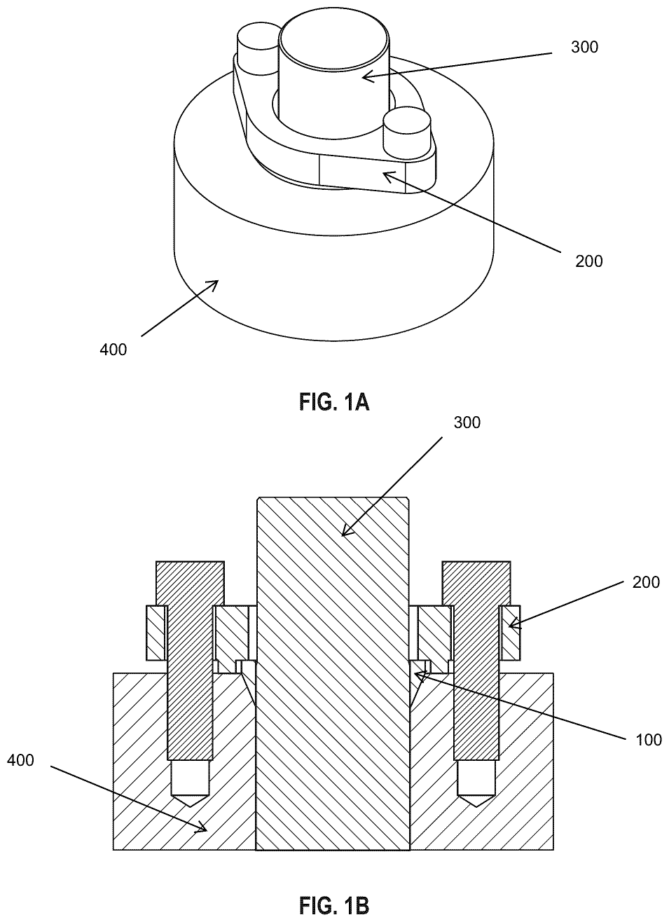

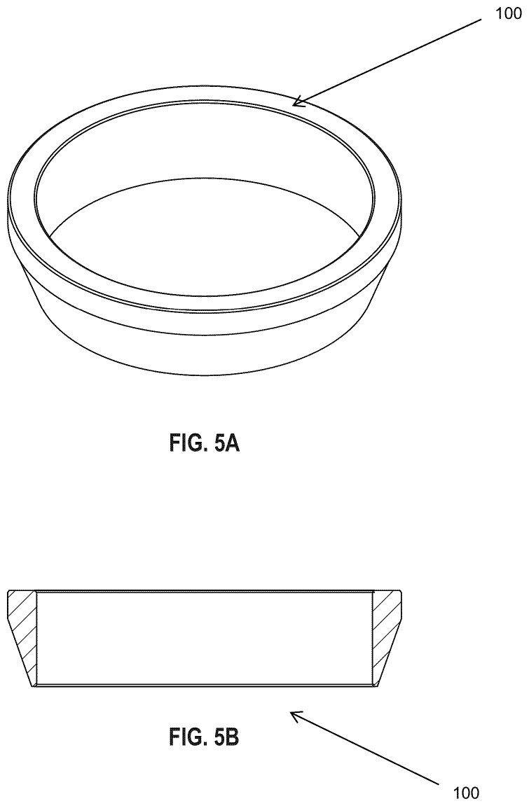

In some embodiments of the present disclosure, shown in FIGS. 1A and 1B, metal ring seal 100 is a metal ring with an inner surface defining a substantially uniform inner diameter for a straight interference fit on the outer diameter of upper mating tube 300. As depicted in FIG. 5, metal ring seal 100 has an outer surface defining an outer diameter that tapers inward toward lower mating tube 400 to provide a tapered interference fit with lower mating tube 400. Force applicator 200 may be a bolted yoke (as shown) or other conventional means of applying load.

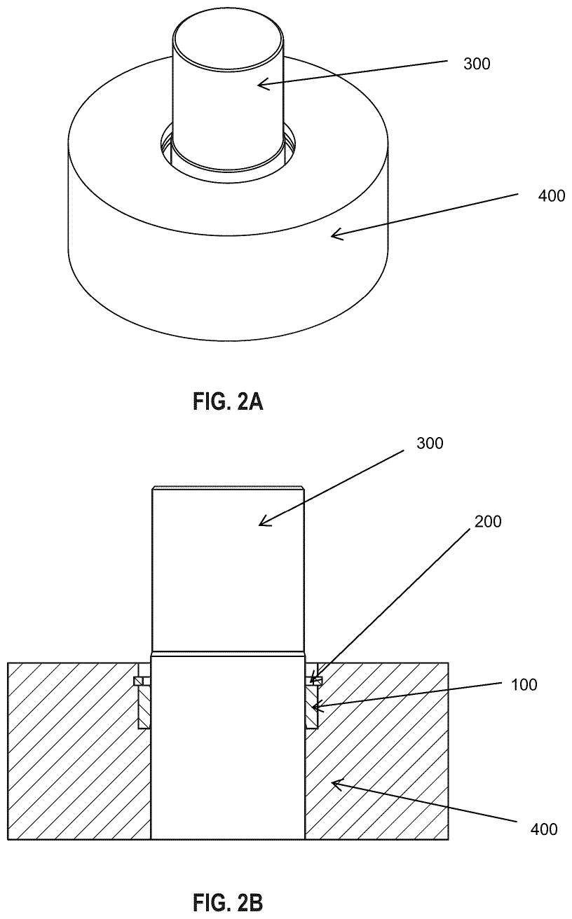

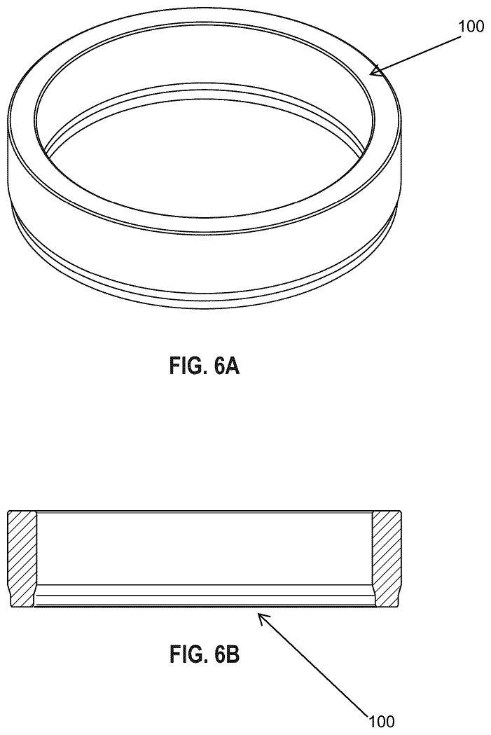

In other embodiments of the present disclosure, shown in FIGS. 2A and 2B, metal ring seal 100 is a metal ring with an inner surface defining a substantially uniform inner diameter for a straight interference fit on the outer diameter of upper mating tube 300. As depicted in FIG. 6, metal ring seal 100 has an outer surface defining a substantially uniform outer diameter to provide a straight interference fit with lower mating tube 400. Force applicator 200 may be a snap ring retainer (as shown) or other conventional means of applying load.

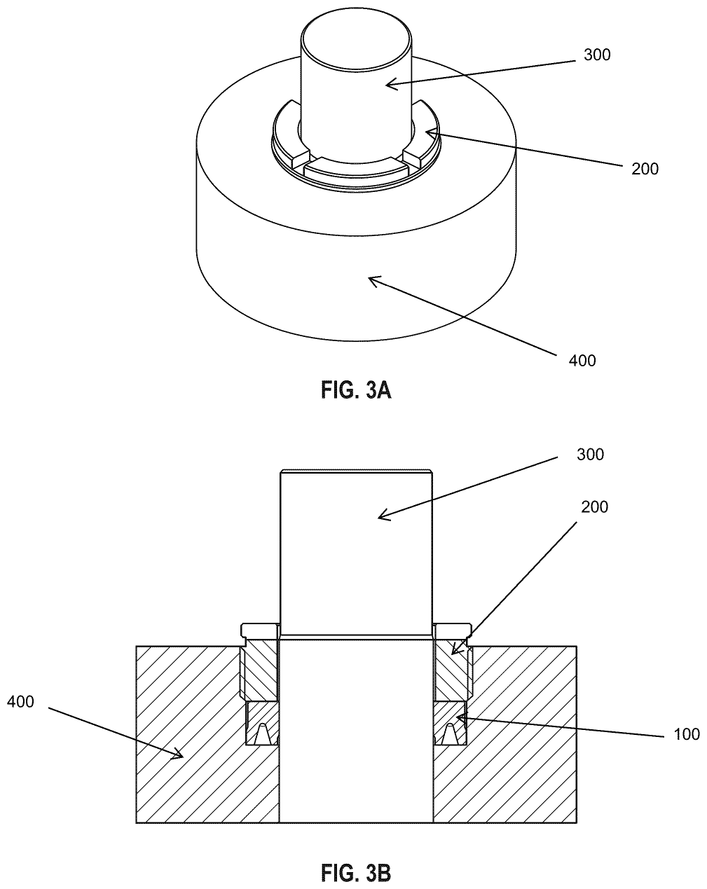

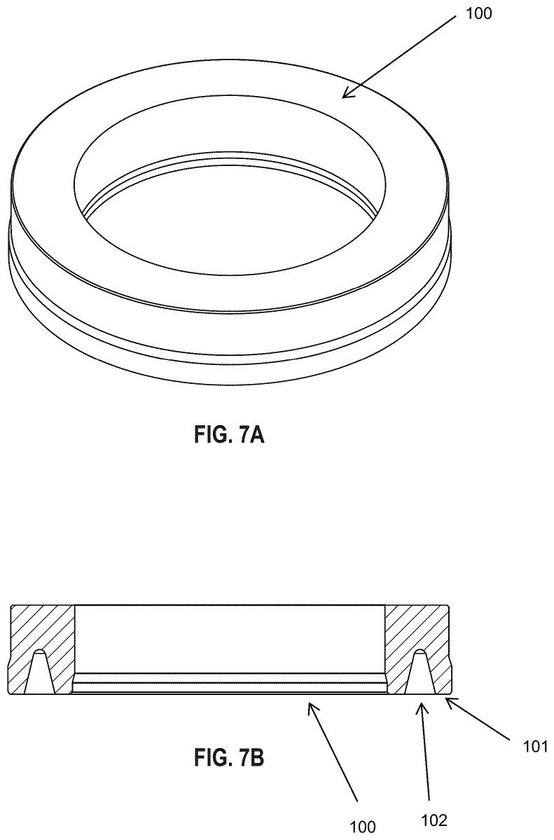

In further embodiments of the present disclosure, shown in FIGS. 3A and 3B, metal ring seal 100 is a metal ring having an inner diameter that tapers slightly outward at a bottom face 101 of metal ring seal 100 and is configured for a straight interference fit on the outer diameter of upper mating tube 300. As depicted in FIG. 7, metal ring seal 100 has an outer diameter that tapers slightly outward at bottom face 101 of metal ring seal 100 and is configured for a flexible interference fit with lower mating tube 400. A groove or channel 102 may be formed into bottom face 101 to provide the slight tapering which accommodates a degree of flexibility when fitting metal ring seal 100 into lower mating tube 400. Force applicator 200 may be a threaded ring (as shown) or other conventional means of applying load.

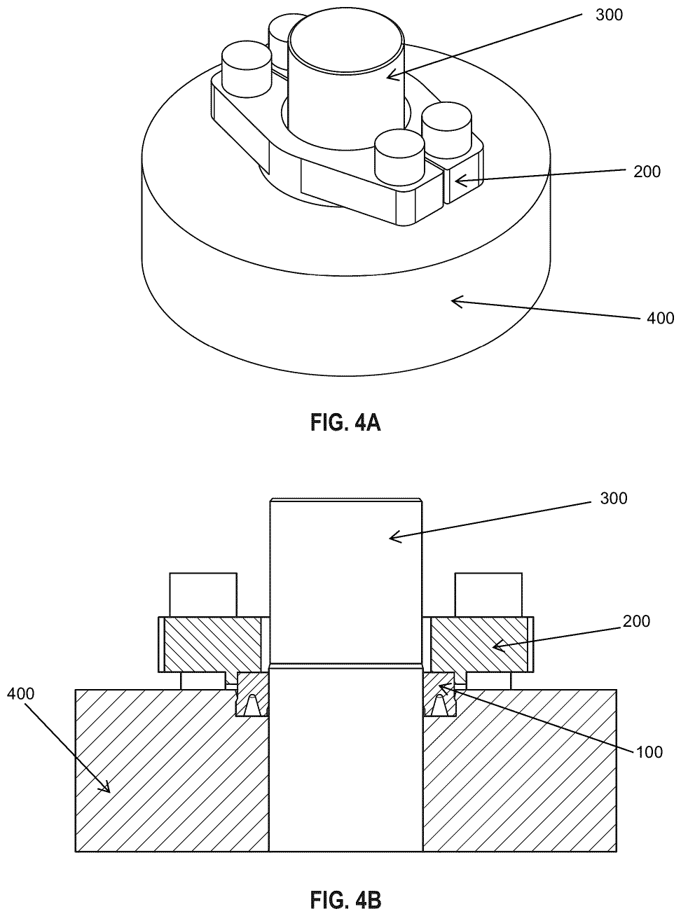

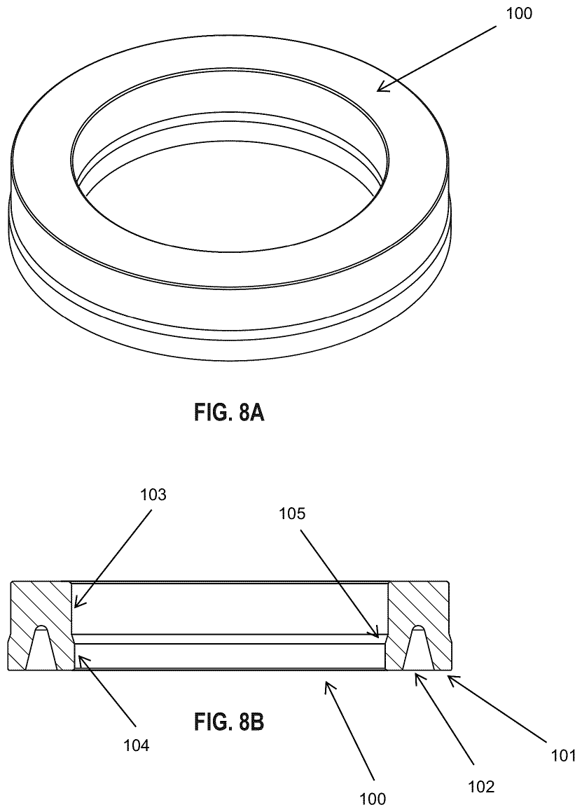

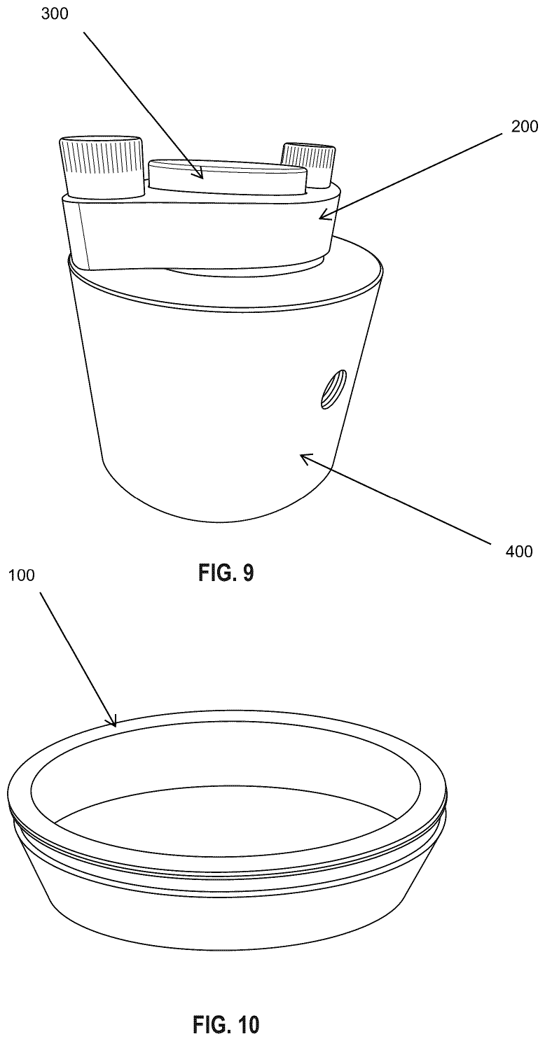

In even further embodiments of the present disclosure, shown in FIGS. 4A and 4B, metal ring seal 100 is a metal ring having a first inner diameter 103 that is larger than a second inner diameter 104. First inner diameter 103 tapers slightly inward to create a lip 105. Second inner diameter 104 tapers slightly outward starting at lip 105 toward bottom face 101 of metal ring seal 100. This provides a flexible interference fit on the outer diameter of upper mating tube 300. As depicted in FIG. 8, metal ring seal 100 has an outer diameter that tapers slightly outward at bottom face 101 of metal ring seal 100 and is configured for a flexible interference fit with lower mating tube 400. A groove or channel 102 may be formed into bottom face 101 to provide the disclosed slight tapering which accommodates a degree of flexibility when fitting metal ring seal 100 into lower mating tube 400. Force applicator 200 may be a split-type clamping yoke (as shown) or other conventional means of applying load.

Metal ring seal 100 may be formed from a material softer than upper mating tube 300 or lower mating tube 400. Depending on the circumstances of use and embodiment of metal seal employed, metal ring seal 100 may be formed from a harder material for resiliency which may be particularly advantageous where flexible friction fits are utilized. The present disclosure also contemplates the use of coatings or corrosion resistant alloys.

In addition, in the preceding description, it can be seen that various features may be grouped in a single embodiment to streamline the disclosure. This method of disclosure is not to be interpreted as reflecting an intention that any claimed embodiments require more features than are expressly recited in each claim. Instead, as the claims reflect, the relevant subject matter lies in less than all features of a single disclosed embodiment. Accordingly, the description should not be interpreted as necessarily limiting the scope of this disclosure only to expressly described embodiments.

What is claimed is:

1. An annular metal sealing system comprising:
an upper mating tube having an upper outer diameter;
a lower mating tube having a lower inner diameter;
a metal ring seal disposed between said upper mating tube and said lower mating tube, wherein said metal ring seal having an inner seal diameter and outer seal diameter; and
an engagement mechanism configured to apply a force upon said metal ring seal and to resist movement of said metal ring seal when said metal ring seal is disposed between said upper mating tube and said lower mating tube.

2. The annular metal sealing system of claim 1 wherein said upper mating tube is an electrical penetrator.

3. The annular metal sealing system of claim 2 wherein said lower mating tube is a housing.

4. The annular metal sealing system of claim 3 wherein said inner seal diameter is substantially uniform and configured to provide a straight interference against said upper outer diameter of said upper mating tube, wherein said outer seal diameter tapers inward toward said lower mating tube and configured to provide a tapered interference fit against said lower inner diameter of said lower mating tube.

5. The annular metal sealing system of claim 4 wherein said engagement mechanism is a clamping yoke disposed around said upper mating tube and secured into said lower mating tube to apply said force to a top face of said metal ring seal.

6. The annular metal sealing system of claim 3 wherein said inner seal diameter is substantially uniform and configured to provide a straight interference against said upper outer diameter of said upper mating tube, wherein said outer seal diameter is substantially uniform and configured to provide a straight interference fit against said lower inner diameter of said lower mating tube.

7. The annular metal sealing system of claim 6 wherein said engagement mechanism is a snap ring retainer disposed around said upper mating tube and within said lower mating tube to resist axial movement of said metal ring seal.

8. The annular metal sealing system of claim 3 wherein said inner seal diameter is substantially uniform and configured to provide a straight interference against said upper outer diameter of said upper mating tube, wherein said outer seal diameter tapers outward toward said lower mating tube, wherein a groove is formed into a bottom face of said metal ring seal to provide a flexible interference fit against said lower inner diameter of said lower mating tube.

9. The annular metal sealing system of claim 8 wherein said engagement mechanism is a threaded driver and hold down ring disposed around said upper mating tube and configured for threaded engagement with said lower mating tube to apply said force to a top face of said metal ring seal.

10. The annular metal sealing system of claim 3 further comprising a lip formed on an inner surface of said metal ring seal, wherein said lip partially defines a first inner seal diameter and a second inner seal diameter, wherein said first inner seal diameter is greater than said second inner seal diameter, said lip having a tapered edge separating said first inner seal diameter and said second inner seal diameter, said inner seal diameter tapering outward toward a bottom face of said metal ring seal, said outer seal diameter tapering outward toward said bottom face, wherein a groove is formed into said bottom face of said metal ring seal to provide a flexible interference fit against said lower inner diameter of said lower mating tube.

11. The annular metal sealing system of claim 10 wherein said engagement mechanism is a split-type clamping yoke disposed around said upper mating tube and secured into said lower mating tube to apply said force to a top face of said metal ring seal.
